(19) United States
(12) Patent Application Publication
(10) Pub. No.: US 2020/0271026 A1
(43) Pub. Date: Aug. 27, 2020

(54) Pneumatic Transmission Fluid Delivery Apparatus

(71) Applicant: George Dixon, Chicago, IL (US)

(72) Inventor: George Dixon, Chicago, IL (US)

(21) Appl. No.: 16/286,737

(22) Filed: Feb. 27, 2019

(51) Int. Cl. F01M 11/04; F16H 57/04

(52) U.S. Cl. CPC F01M 11/04; F16H 57/0408

(57) ABSTRACT

A pneumatic transmission fluid delivery apparatus for quick and effective transmission fluid replenishment includes a fluid container and a fluid cap to seal and alternatively expose an inner compartment. An air supply channel is coupled to the fluid container and is in fluid communication with an air aperture. An air hose adaptor is coupled to the air supply channel and is in fluid communication with the air supply channel and is configured to receive a compressor hose to pass compressed air through the air aperture into the fluid container. A fluid tube is coupled to the fluid container and is in fluid communication with an output aperture to deliver pressurized transmission fluid stored in the fluid container to a vehicle transmission.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to fluid delivery apparatuses and more particularly pertains to a new fluid delivery apparatus for quick and effective transmission fluid replenishment.

### BRIEF SUMMARY OF THE INVENTION

An embodiment of the disclosure meets the needs presented above by generally comprising a fluid container having a top end, a bottom end, and a sidewall extending therebetween forming an inner compartment. The top end has a fill aperture extending through to the inner compartment, the bottom end has an output aperture extending through to the inner compartment, and the sidewall has an air aperture extending through to the inner compartment proximal the top end. A fluid cap is coupled to the fluid container and is selectively engageable with the fill aperture to seal and alternatively expose the inner compartment. An air supply channel is coupled to the fluid container and is in fluid communication with the air aperture. An air hose adaptor is coupled to a distal end of the air supply channel and is in fluid communication with the air supply channel and is configured to receive a compressor hose to pass compressed air through the air aperture into the fluid container. A fluid tube is coupled to the fluid container and is in fluid communication with the output aperture. The fluid tube is configured to deliver pressurized transmission fluid stored in the fluid container to a vehicle transmission.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a pneumatic transmission fluid delivery apparatus according to an embodiment of the disclosure.

FIG. 2 is a front elevation view of an embodiment of the disclosure.

FIG. 3 is a cross-sectional view of an embodiment of the disclosure along line 3-3 of FIG. 2.

### DETAILED DESCRIPTION OF THE INVENTION

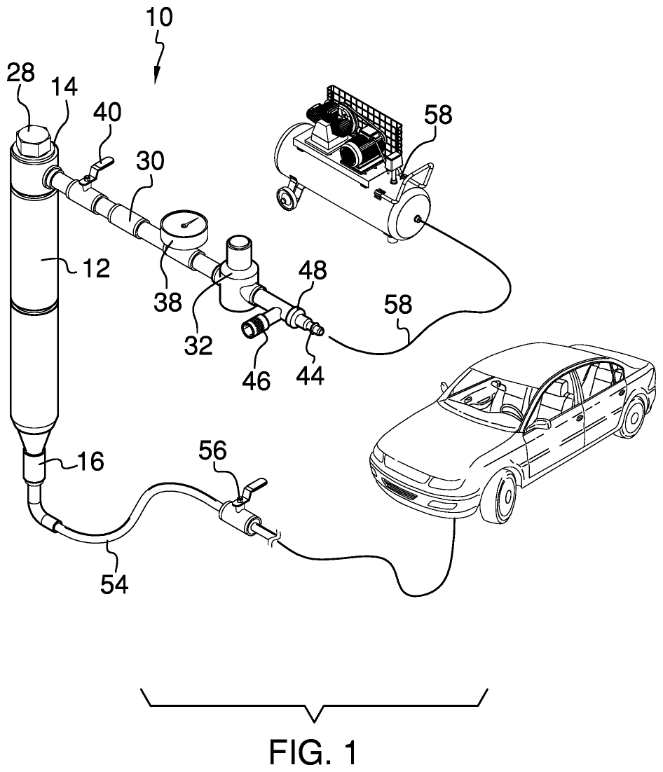

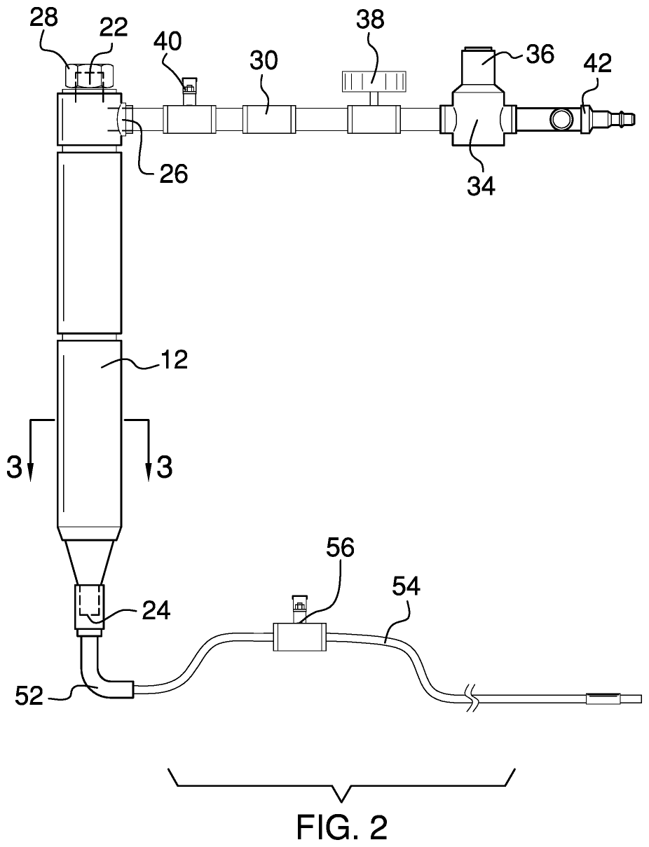

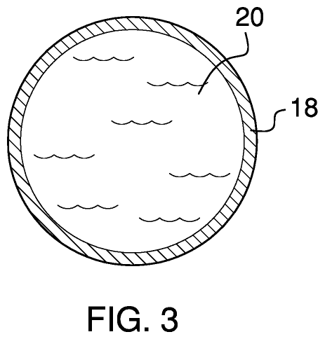

With reference now to the drawings, and in particular to FIGS. 1 through 3 thereof, a new fluid delivery apparatus embodying the principles and concepts of an embodiment of the disclosure and generally designated by the reference numeral 10 will be described.

As best illustrated in FIGS. 1 through 3, the pneumatic transmission fluid delivery apparatus 10 generally comprises a fluid container 12 having a top end 14, a bottom end 16, and a sidewall 18 extending therebetween forming an inner compartment 20. The top end 14 has a fill aperture 22 extending through to the inner compartment 20, the bottom end 16 has an output aperture 24 extending through to the inner compartment 20, and the sidewall 18 has an air aperture 26 extending through to the inner compartment 20 proximal the top end 14. The fluid container 12 may taper towards the bottom end 16. The inner compartment 20 is configured to store transmission fluid and may be filled via the fill aperture 22. A fluid cap 28 is coupled to the fluid container 12 and is selectively engageable with the fill aperture 22 to seal and alternatively expose the inner compartment 20. The fluid cap 28 may be faceted. An air supply channel 30 is coupled to the fluid container 12 and is in fluid communication with the air aperture 26.

An air pressure valve 32 is coupled to the air supply channel 30. The air pressure valve 32 has a valve housing 34 and a rotatable dial 36 coupled to the valve housing 34.

The rotatable dial 36 adjusts the amount of air pressure delivered to the air aperture 26. Each of the valve housing 34 and the rotatable dial 36 may be cylindrical. A pressure gauge 38 is coupled to the air supply channel 30 and is in operational communication with the air supply channel 30 to measure the pressure of air flow between the air pressure valve 32 and the air aperture 26. A shut-off valve 40 is coupled to the air supply channel 30 to close and alternatively open the air supply channel 30, thus preventing and alternatively allowing the flow of pressurized air to the air aperture 26. An air hose adaptor 42 is coupled to the air supply channel 30. The air hose adaptor 42 may comprise a nipple adaptor 44 and a quick-release adaptor 46. The quick-release adaptor 46 is perpendicularly coupled to the air supply channel 30 and the nipple adaptor 44 is colinearly coupled to a distal end 48 of the air supply channel. The air hose adaptor 42 is in fluid communication with the air supply channel 30 and is configured to receive a compressor hose 50 to pass compressed air through the air aperture 26 into the fluid container 12.

An elbow extension 52 may be coupled to the bottom end 16 of the fluid container and is in fluid communication with the output aperture 24. The elbow extension 52 may form a right angle. A fluid tube 54 is coupled to the elbow extension 52. The fluid tube 54 is in fluid communication with the elbow extension 52 and is configured to deliver pressurized transmission fluid stored in the fluid container 12 to a vehicle transmission.

A leak valve 56 is coupled to the fluid tube 54. The leak valve 56 closes and alternatively opens the fluid tube 54 to prevent and alternatively allow the flow of pressurized transmission fluid through the fluid tube 54.

In use, a user fills the inner compartment 20 of the fluid container with transmission fluid through the fill aperture 22 and then engages the fill cap 28 to seal the fill aperture 22. The compressor hose 50 is engaged with the air hose adaptor 42 and a compressor 58 connected to the air host adaptor 42 is turned on. The air pressure valve 32 is adjusted as desired by monitoring the pressure gauge 38. The fluid tube 54 is placed into the vehicle transmission and the shut-off valve 40 is opened to begin the flow of transmission fluid. When complete, the leak valve 56 may first be closed to prevent the flow of transmission fluid, then the shut-off valve 40 is closed to prevent further pressurization of the inner compartment 20. The compressor hose 50 is then disengaged and the compressor 58 is turned off.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pneumatic transmission fluid delivery apparatus comprising:
a fluid container having a top end, a bottom end, and a sidewall extending therebetween forming an inner compartment, the top end having a fill aperture extending through to the inner compartment, the bottom end having an output aperture extending through to the inner compartment, and the sidewall having an air aperture extending through to the inner compartment proximal the top end;
a fluid cap coupled to the fluid container, the fluid cap being selectively engageable with the fill aperture to seal and alternatively expose the inner compartment;
an air supply channel coupled to the fluid container, the air supply channel being in fluid communication with the air aperture;
an air hose adaptor coupled to the air supply channel, the air hose adaptor being coupled to a distal end of the air supply channel, the air hose adaptor being in fluid communication with the air supply channel and configured to receive a compressor hose to pass compressed air through the air aperture into the fluid container; and
a fluid tube coupled to the fluid container, the fluid tube being in fluid communication with the output aperture, the fluid tube being configured to deliver pressurized transmission fluid stored in the fluid container to a vehicle transmission.

2. The pneumatic transmission fluid delivery apparatus of claim 1 further comprising an air pressure valve coupled to the air supply channel, the air pressure valve adjusting the amount of air pressure delivered to the air aperture.

3. The pneumatic transmission fluid delivery apparatus of claim 2 further comprising a pressure gauge coupled to the air supply channel, the pressure gauge being in operational communication with the air supply channel to measure the pressure of air flow between the air pressure valve and the air aperture.

4. The pneumatic transmission fluid delivery apparatus of claim 1 further comprising a shut-off valve coupled to the air supply channel, the shut-off valve closing and alternatively opening the air supply channel thus preventing and alternatively allowing the flow of pressurized air to the air aperture.

5. The pneumatic transmission fluid delivery apparatus of claim 1 further comprising the air hose adaptor comprising a nipple adaptor and a quick-release adaptor, the quick-release adaptor being perpendicularly coupled to the air supply channel and the nipple adaptor being colinear with the air supply channel.

6. The pneumatic transmission fluid delivery apparatus of claim 1 further comprising the fluid container tapering towards the bottom end.

7. The pneumatic transmission fluid delivery apparatus of claim 1 further comprising an elbow extension coupled to the bottom end of the fluid container, the elbow extension being in fluid communication with the output aperture, the fluid tube being coupled to the elbow extension.

8. The pneumatic transmission fluid delivery apparatus of claim 7 further comprising the elbow extension being forming a right angle.

9. The pneumatic transmission fluid delivery apparatus of claim 1 further comprising the fluid cap being faceted.

10. The pneumatic transmission fluid delivery apparatus of claim 2 further comprising the air pressure valve having a valve housing and a rotatable dial coupled to the valve housing, the rotatable dial adjusting the amount of air pressure delivered to the air aperture.

11. The pneumatic transmission fluid delivery apparatus of claim 10 further comprising each of the valve housing and the rotatable dial being cylindrical.

12. The pneumatic transmission fluid delivery apparatus of claim 1 further comprising a leak valve coupled to the fluid tube, the leak valve closing and alternatively opening the fluid tube thus preventing and alternatively allowing the flow of pressurized fluid through the fluid tube.

13. A pneumatic transmission fluid delivery apparatus comprising:
a fluid container having a top end, a bottom end, and a sidewall extending therebetween forming an inner compartment, the top end having a fill aperture extending through to the inner compartment, the bottom end having an output aperture extending through to the inner compartment, and the sidewall having an air aperture extending through to the inner compartment proximal the top end, the fluid container tapering towards the bottom end;
a fluid cap coupled to the fluid container, the fluid cap being selectively engageable with the fill aperture to seal and alternatively expose the inner compartment, the fluid cap being faceted;
an air supply channel coupled to the fluid container, the air supply channel being in fluid communication with the air aperture;
an air pressure valve coupled to the air supply channel, the air pressure valve having a valve housing and a rotatable dial coupled to the valve housing, the rotatable dial adjusting the amount of air pressure delivered to the air aperture, each of the valve housing and the rotatable dial being cylindrical;
a pressure gauge coupled to the air supply channel, the pressure gauge being in operational communication with the air supply channel to measure the pressure of air flow between the air pressure valve and the air aperture;
a shut-off valve coupled to the air supply channel, the shut-off valve closing and alternatively opening the air supply channel thus preventing and alternatively allowing the flow of pressurized air to the air aperture;
an air hose adaptor coupled to the air supply channel, the air hose adaptor comprising a nipple adaptor and a quick-release adaptor, the quick-release adaptor being perpendicularly coupled to the air supply channel and the nipple adaptor being colinearly coupled to a distal end of the air supply channel, the air hose adaptor being in fluid communication with the air supply channel and configured to receive a compressor hose to pass compressed air through the air aperture into the fluid container;
an elbow extension coupled to the bottom end of the fluid container, the elbow extension being in fluid communication with the output aperture, the elbow extension forming a right angle;
a fluid tube coupled to the elbow extension, the fluid tube being in fluid communication with the elbow extension, the fluid tube being configured to deliver pressurized transmission fluid stored in the fluid container to a vehicle transmission; and
a leak valve coupled to the fluid tube, the leak valve closing and alternatively opening the fluid tube thus preventing and alternatively allowing the flow of pressurized fluid through the fluid tube.

14. A combination compressor and pneumatic transmission fluid delivery apparatus comprising:
a compressor, the compressor delivering compressed air through a compressor hose;
a fluid container having a top end, a bottom end, and a sidewall extending therebetween forming an inner compartment, the top end having a fill aperture extending through to the inner compartment, the bottom end having an output aperture extending through to the inner compartment, and the sidewall having an air aperture extending through to the inner compartment proximal the top end, the fluid container tapering towards the bottom end;
a fluid cap coupled to the fluid container, the fluid cap being selectively engageable with the fill aperture to seal and alternatively expose the inner compartment, the fluid cap being faceted;
an air supply channel coupled to the fluid container, the air supply channel being in fluid communication with the air aperture;
an air pressure valve coupled to the air supply channel, the air pressure valve having a valve housing and a rotatable dial coupled to the valve housing, the rotatable dial adjusting the amount of air pressure delivered to the air aperture, each of the valve housing and the rotatable dial being cylindrical;
a pressure gauge coupled to the air supply channel, the pressure gauge being in operational communication with the air supply channel to measure the pressure of air flow between the air pressure valve and the air aperture;
a shut-off valve coupled to the air supply channel, the shut-off valve closing and alternatively opening the air supply channel thus preventing and alternatively allowing the flow of pressurized air to the air aperture;
an air hose adaptor coupled to the air supply channel, the air hose adaptor comprising a nipple adaptor and a quick-release adaptor, the quick-release adaptor being perpendicularly coupled to the air supply channel and the nipple adaptor being colinearly coupled to a distal end of the air supply channel, the air hose adaptor being in fluid communication with the air supply channel and receiving the compressor hose to pass compressed air through the air aperture into the fluid container;
an elbow extension coupled to the bottom end of the fluid container, the elbow extension being in fluid communication with the output aperture, the elbow extension forming a right angle;
a fluid tube coupled to the elbow extension, the fluid tube being in fluid communication with the elbow extension, the fluid tube being configured to deliver pressurized transmission fluid stored in the fluid container to a vehicle transmission; and
a leak valve coupled to the fluid tube, the leak valve closing and alternatively opening the fluid tube thus preventing and alternatively allowing the flow of pressurized fluid through the fluid tube.
